(19) United States
(12) Patent Application Publication
(10) Pub. No.: US 2008/0316346 A1
(43) Pub. Date: Dec. 25, 2008

(54) Color solid-state image pickup device and method for reading out pixel signals

(75) Inventor: Takashi Watanabe, Kyoto (JP)

Correspondence Address: Edwards Angell Palmer & Dodge LLP, P.O. Box 55874, Boston, MA, 02205, US

(73) Assignee: Sharp Kabushiki Kaisha, Osaka (JP)

(21) Appl. No.: 12/214,744

(22) Filed: Jun. 20, 2008

(30) Foreign Application Priority Data
Jun. 21, 2007 (JP) 2007-164324

(51) Int. Cl. H04N 5/335

(52) U.S. Cl. 348/294

(57) ABSTRACT

A color solid-state image pickup device includes a pixel section having sets of a total of four adjacent pixels arrayed 2×2 in horizontal and vertical directions. Each of the sets consists of an first pixel serving as an upper left pixel and having a first spectral characteristic, a second pixel serving as an upper right pixel and having a second spectral characteristic, a third pixel serving as a lower left pixel and having a third spectral characteristic, and a fourth pixel serving as a lower right pixel and having a fourth spectral characteristic. The pixel section is formed by arraying the sets in the horizontal and vertical directions so that the sets form a matrix. The color solid-state image pickup device uses, as a unit of addition, a total of 16 pixels consisting of four adjacent sets arrayed 2×2 in the horizontal and vertical directions. The color solid-state image pickup device adds up and reads out respective pixel signals of the pixels. The color solid-state image pickup device creates a luminance signal by adding up and reading out respective pixel signals of the first, second, third, and fourth pixels constituting the set. This makes it possible to achieve both high sensitivity and high resolution by inhibiting the resolution from being reduced by adding up pixel signals.

This Nonprovisional application claims priority under U.S.C. § 119(a) on Patent Application No. 164324/2007 filed in Japan on Jun. 21, 2007, the entire contents of which are hereby incorporated by reference.

### FIELD OF THE INVENTION

The present invention relates to color solid-state image pickup devices each having color filters formed in a mosaic pattern. More specifically, the present invention relates to a technique for, in order to improve the sensitivity of a high-resolution element, adding up and reading out pixel signals.

### BACKGROUND OF THE INVENTION

Generally, a color solid-state image pickup device includes a pixel region (pixel section) formed by arraying plural types of color filters of different spectral characteristics at regular space periods on light-incident surfaces of a large number of pixels arrayed in a matrix manner. That is, the plural types of color filters are disposed so that one type of color filter is assigned to one pixel.

In FIG. 7, (a) shows an example arrangement of a color solid-state image pickup device's pixel section in which four types of color filters C1, C2, C3, and C4 are arrayed so as to be assigned to a set of a total of four pixels arrayed 2×2 in the horizontal and vertical directions. The pixel section includes: a pixel array layer having a large number of pixels so arrayed in the horizontal and vertical directions as to form a matrix; and a color filter layer, provided on a light-incident surface of the pixel array layer, which has plural types of color filters so arrayed as to be assigned to the respective pixels.

Further, an array in which the four types of color filters C1, C2, C3, and C4 of (a) of FIG. 7 are C1=Gr (Green 1), C2=R (Red), C3=B (Blue), and C4=Gb (Green 2) as shown in (a) of FIG. 8, respectively, is known as a “Bayer array”. Although Gr and Gb are generally supposed to have the same spectral characteristic, the following assumes, for identification, that Gr and Gb are different signs.

Now, color solid-state image pickup devices are being developed so as to provide improved resolution, and color solid-state image pickup devices are commercialized year after year so as to provide ever-higher resolution. The “resolution” is a measure of how finely an image can be expressed. The higher the resolution, the more naturally the image looks.

However, a mere improvement in resolution causes a problem. For example, Japanese Unexamined Patent Application Publication No. 36920/2001 (Tokukai 2001-36920; published on Feb. 9, 2001) describes a technique for, in order to solve such a problem that a high-resolution camera is used mainly for still images and has difficulty in taking moving images, adding up a plurality of pixel signals so that a spatial array of colors before the adding up and a spatial array of colors after the adding up are identical. This prevents deterioration in moving images taken.

Further, in recent years, color solid-state image pickup devices mainly for use in mobile image input products have been developed so as to have an increased total number of pixels and a reduced optical size. In this case, the size of a pixel is drastically reduced and the sensitivity and signal saturation amount of a pixel become lower and smaller. This makes it more difficult to ensure performance. In other words, in order to increase the number of pixels, i.e., to increase resolution while maintaining an optical size, it is necessary to reduce the size of a pixel on the one hand and to maintain sensitivity on the other. For this reason, recent solid-state image pickup devices have been required to reduce the size of a pixel on the one hand and to maintain sensitivity on the other. Currently, each manufacturer advances development in the order of 8 M (8 million pixels).

In order to increase sensitivity and signal saturation amounts and to ensure performance, it is useful to add up and read out pixel signals. In particular, for use under conditions of low-light intensity, a technique for increasing sensitivity by adding up pixel signals is employed. In an image pickup device having a large number of fine pixels, adding up and reading out pixel signals at the time of low-light intensity or the like are effective in increasing sensitivity, increasing readout frame rates, and suppressing moiré.

The adding up of pixel signals will be described by taking, as an example, the case of adding up a total of four pixels arrayed 2×2 as shown in (a) of FIG. 7. In this case, since it is necessary to add up identical colors, a total of 16 pixels arrayed 4×4 serve as a unit of addition. Moreover, as shown in (b) of FIG. 7, pixel signals of pixels assigned the same color among the total of 16 pixels are added up and read out.

For example, the total of 16 pixels have four pixels assigned color filters C1. Therefore, a color signal sC1 is read out by adding up pixel signals of the four pixels. The color signal sC1 serves as a color signal corresponding to one pixel per unit of addition. That is, as indicated as “C1” in capital and bold letters in (b) of FIG. 7, the color signal sC1 serves as a color signal containing color information of a color filter C1 corresponding to one pixel per unit of addition.

Thus, color signals sC1, sC2, sC3, and sC4 each added up so as to correspond to one pixel per unit of addition are obtained. Further, each of the color signals sC1, sC2, sC3, and sC4 is obtained by adding up four pixel signals. This makes it possible to obtain high sensitivity corresponding to four pixels added up.

Similarly, in the case of adding up a total of four pixels arrayed 2×2 as shown in the Bayer array of (a) of FIG. 8, color signals sGr, sR, sB, and sGb, each added up so as to correspond to one pixel per unit of addition, which respectively contain color information of Green 1 (Gr), color information of Red (R), color information of Blue (B), and color information of Green 2 (Gb) are obtained as shown in (b) of FIG. 8.

However, such a method for adding up pixel signals cannot avoid a problem with a drastic reduction in resolution. That is, since the adding-up method makes it necessary to add up identical colors, the additive method uses, as a unit of addition, a total of 16 pixels arrayed 4×4, and adds up only pixel signals containing color information of spatially dispersed color filters of the same color. This results in the creation of one pixel signal per unit of addition from each of the four colors of the color filters C1, C2, C3, and C4.

This undesirably causes the resolution to be ¼ both in the horizontal and vertical directions and ¼×¼ of a full pixel, so that the resolution is drastically reduced to 1/16 in total in terms of the number of pixels. Therefore, even an 8-M element is made equivalent to a 0.5-M (500,000 pixels) element. Such a solid-state image pickup device can only be used for an image monitor or the like, and is at such a level as to be unusable for taking still images.

### SUMMARY OF THE INVENTION

The present invention has been made in view of the foregoing problems, and it is an object of the present invention to provide a color solid-state image pickup device and a method for reading out pixel signals, each of which achieves both high sensitivity and high resolution by inhibiting the resolution from being reduced by adding up pixel signals.

In order to solve the foregoing problems, a color solid-state image pickup device of the present invention is a color solid-state image pickup device including a pixel section having sets of a total of four adjacent pixels arrayed 2×2 in horizontal and vertical directions, each of the sets consisting of an first pixel serving as an upper left pixel and having a first spectral characteristic, a second pixel serving as an upper right pixel and having a second spectral characteristic, a third pixel serving as a lower left pixel and having a third spectral characteristic, and a fourth pixel serving as a lower right pixel and having a fourth spectral characteristic, the pixel section being formed by arraying the sets in the horizontal and vertical directions so that the sets forms a matrix, the color solid-state image pickup device using, as a unit of addition, a total of 16 pixels consisting of four adjacent sets arrayed 2×2 in the horizontal and vertical directions, the color solid-state image pickup device adding up and reading out respective pixel signals of the pixels, the color solid-state image pickup device creating a luminance signal by adding up and reading out respective pixel signals of the first, second, third, and fourth pixels constituting the set.

Conventionally, in the case of adding up and reading out pixel signals in such a set of a total of four adjacent pixels arrayed 2×2 in the horizontal and vertical directions, a total of 16 adjacent pixels arrayed 4×4 in the horizontal and vertical directions serves as a unit of addition, because it is necessary to add up pixel signals having the same spectral characteristic. Moreover, in the total of 16 pixels, i.e., in the unit of addition, pixel signals having the same spectral characteristic are added up among pixel signals having a first spectral characteristic, pixel signals having a second spectral characteristic, pixel signals having a third spectral characteristic, and pixel signals having a fourth spectral characteristic. Thus, one pixel signal is created per unit of addition for each of the first, second, third, and fourth spectral characteristics. This undesirably causes the resolution to be ¼ both in the horizontal and vertical directions and ¼×¼ of a full pixel, so that the resolution is drastically reduced to 1/16 in total in terms of the number of pixels.

On the other hand, according to the foregoing arrangement of the color solid-state image pickup device of the present invention, the luminance signal is created by adding up and reading out respective pixel signals of the first, second, third, and fourth pixels constituting the set. Therefore, the luminance signal, which is required to be of high resolution, is obtained in a unit of 2×2 pixels. This causes the resolution to be ½ both in the horizontal and vertical directions and ½×½ of a full pixel, so that the resolution is ¼ in total in terms of the number of pixels.

This makes it possible to achieve a fourfold increase in resolution in comparison with the conventional adding-up method by inhibiting the resolution from being reduced by such adding up of pixel signals as performed by the conventional adding-up method. Furthermore, since the luminance signal is created by adding up pixel signals corresponding to four pixels, it becomes possible to achieve a fourfold increase in sensitivity. This makes it possible to achieve both high sensitivity and high resolution by inhibiting the resolution from being reduced by adding up pixel signals.

Further, a method of the present invention for reading out pixel signals is a method for reading out pixel signals in a color solid-state image pickup device including a pixel section having sets of a total of four adjacent pixels arrayed 2×2 in horizontal and vertical directions, each of the sets consisting of an first pixel serving as an upper left pixel and having a first spectral characteristic, a second pixel serving as an upper right pixel and having a second spectral characteristic, a third pixel serving as a lower left pixel and having a third spectral characteristic, and a fourth pixel serving as a lower right pixel and having a fourth spectral characteristic, the pixel section being formed by arraying the sets in the horizontal and vertical directions so that the sets forms a matrix, the color solid-state image pickup device using, as a unit of addition, a total of 16 pixels consisting of four adjacent sets arrayed 2×2 in the horizontal and vertical directions, the color solid-state image pickup device adding up and reading out respective pixel signals of the pixels, the method including: a first step of creating a luminance signal by adding up and reading out respective pixel signals of the first, second, third, and fourth pixels constituting the set; and a second step of, in the unit of addition, creating color signals by adding up and reading out pixel signals of pixels in accordance with colors corresponding to the pixels, respectively.

According to the foregoing arrangement, the luminance signal is created by adding up and reading out respective pixel signals of the first, second, third, and fourth pixels constituting the set. Further, the color signals are created after the luminance signal. This makes it possible to easily obtain color signals.

Further, the luminance signal, which is required to be of high resolution, is obtained in a unit of 2×2 pixels. This causes the resolution to be ½ both in the horizontal and vertical directions and ½×½ of a full pixel, so that the resolution is ¼ in total in terms of the number of pixels.

Therefore, whereas the conventional adding-up method has drastically reduced the resolution to 1/16 in total in terms of the number of pixels, the color solid-state image pickup device of the present invention can achieve a fourfold increase in resolution in comparison with the conventional adding-up method. Furthermore, since the luminance signal is created by adding up pixel signals corresponding to four pixels, it becomes possible to achieve a fourfold increase in sensitivity. This makes it possible to achieve both high sensitivity and high resolution by inhibiting the resolution from being reduced by adding up pixel signals.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 schematically shows an example of a method for adding up in a color solid-state image pickup device of the present invention.

FIG. 2 shows an embodiment of the color solid-state image pickup device.

FIG. 3 shows another example arrangement of an analog signal storage section of the color solid-state image pickup device.

FIG. 4 schematically shows a method for adding up at the time of a Bayer array in the color solid-state image pickup device of the present invention.

FIG. 5 schematically shows another method for adding up in the color solid-state image pickup device of the present invention.

FIGS. 6(a) through 6(d) are color-filter-array diagrams showing various example arrays of color filters.

FIG. 7 schematically shows a conventional adding-up method.

FIG. 8 schematically shows a conventional method for adding up at the time of a Bayer array.

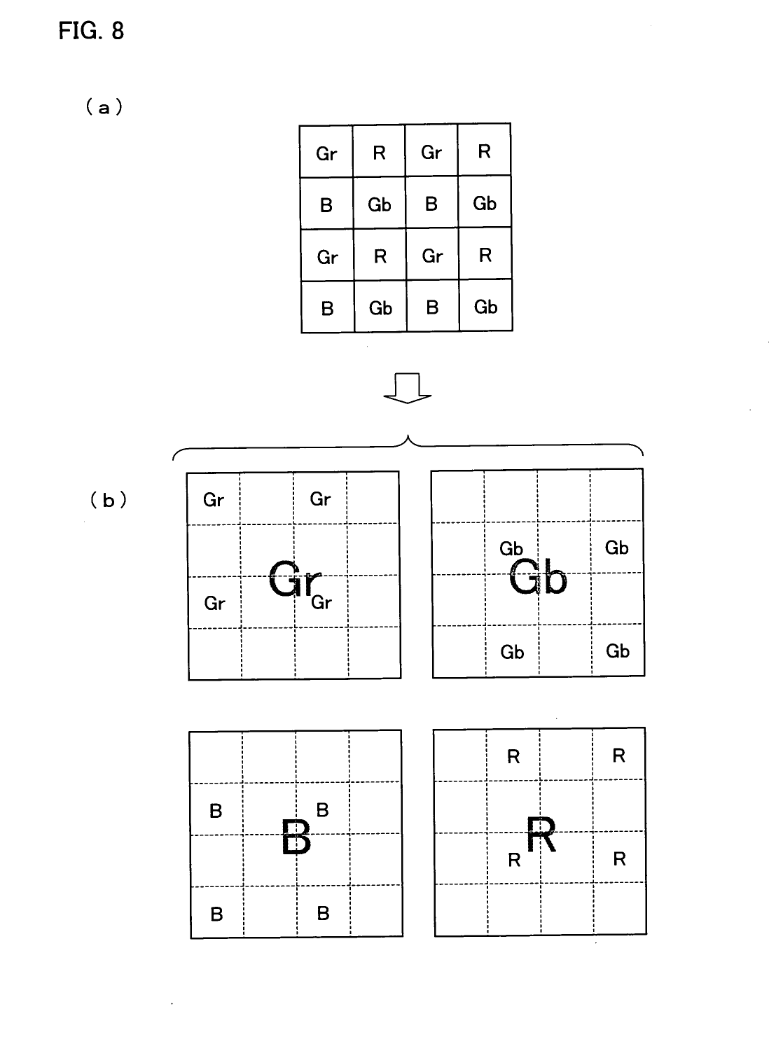

### DESCRIPTION OF THE EMBODIMENTS

An embodiment of the present invention will be described below with reference to the drawings.

The following first describes the adding up of pixel signals, which is a feature arrangement of a color solid-state image pickup device of the present embodiment. The following then describes a circuit arrangement of the color solid-state image pickup device of the present embodiment for realizing the adding up of pixel signals.

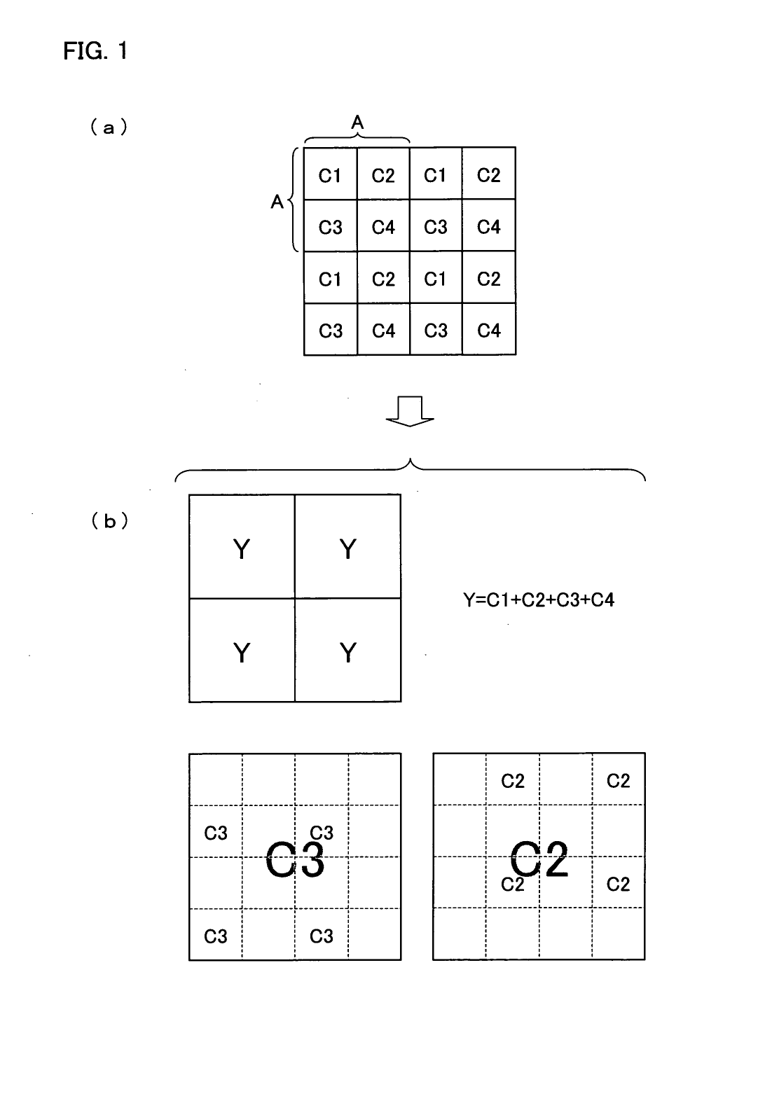

FIG. 1 explains an example of a method for adding up in a pixel section of the color solid-state image pickup device of the present embodiment. In FIG. 1, (a) shows a color filter array, and (b) schematically shows a method for adding up pixel signals.

The pixel section of the color solid-state image pickup device of the present embodiment includes: a pixel array layer having a large number of pixels so arrayed as to form a matrix; and a color filter layer, provided on a light-incident surface of the pixel array layer, which has plural types of color filters of different spectral characteristics so arrayed at regular space periods as to be assigned to the respective pixels.

In the color solid-state image pickup device of the present embodiment, a large number of pixels constitute sets of two adjacent pixels arrayed in the horizontal direction and two pixels arrayed in the vertical direction, i.e., of a total of four adjacent pixels arrayed 2×2 in the horizontal and vertical directions. Each of the sets has four types of color filters C1, C2, C3, and C4 assigned thereto. Specifically, as shown in (a) of FIG. 1, a set A of adjacent pixels arrayed 2×2 in the horizontal and vertical directions has a color filter C1 assigned to an upper left pixel thereof, a color filter C2 assigned to an upper right pixel thereof, a color filter C3 assigned to a lower left pixel thereof, and a color filter C4 assigned to a lower right pixel thereof. Moreover, a plurality of such sets A are arrayed in the horizontal and vertical directions. It should be noted that a pixel assigned a color filter corresponds to a color to which the color filter has been set.

Further, the color solid-state image pickup device of the present embodiment adds up and reads out pixel signals of pixels assigned such color filters. In so doing, the color solid-state image pickup device of the present embodiment uses, as a unit of addition, a total four adjacent sets arrayed 2×2 in the horizontal and vertical directions, i.e., a total of 16 pixels arrayed 4×4. For convenience of explanation, FIG. 1 shows only the unit of addition.

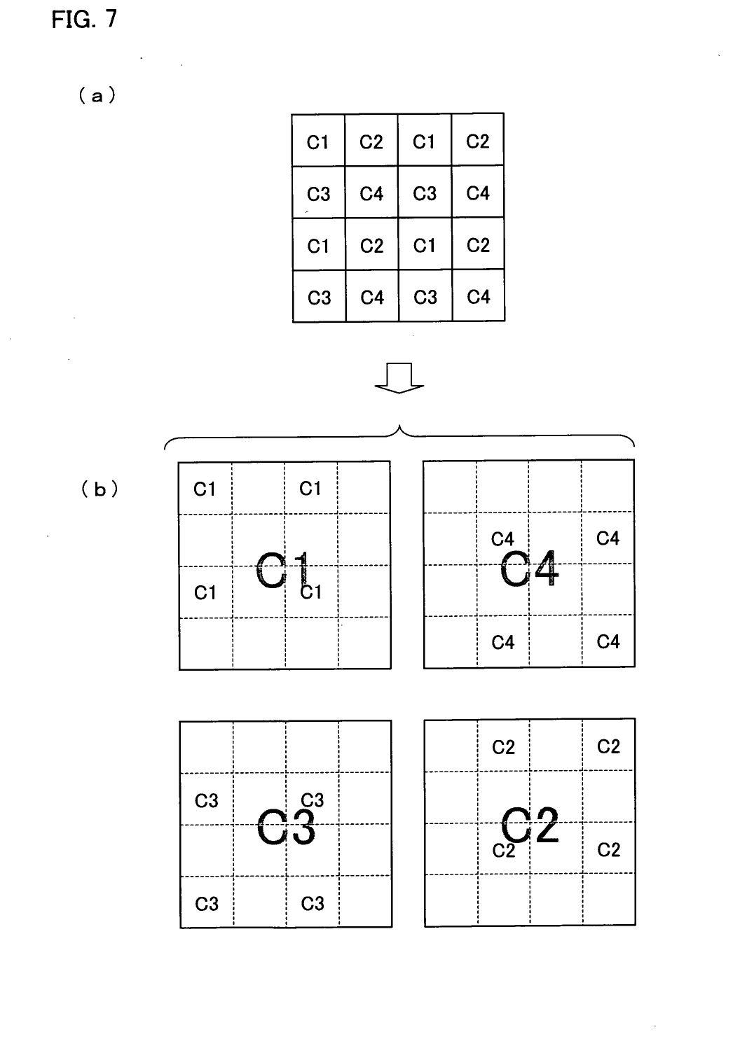

In cases where the conventional color solid-state image pickup device adds up pixel signals, the conventional color solid-state image pickup device uses a total of 16 pixels, i.e., 4×4 pixels as a unit of addition as shown in FIG. 7, and yields color signals sC1, sC2, sC3, and sC4 each added up so as to correspond to one pixel per unit of addition. This causes the resolution to be ¼ both in the horizontal and vertical directions, so that the resolution is drastically reduced to 1/16 in total in terms of the number of pixels.

On the other hand, the color solid-state image pickup device of the present embodiment uses a total of 16 pixels, i.e., 4×4 pixels as a unit of addition, adds up pixel signals within a set of 2×2 adjacent pixels as shown in (b) of FIG. 1, and yields “Y=C1+C2+C3+C4 (where, for convenience of explanation, C1, C2, C3, and C4 indicate pixel signals of pixels assigned color filters C1, C2, C3, and C4, respectively)”. Y serves as a luminance signal because it contains all color information. That is, the color solid-state image pickup device of the present embodiment creates a luminance signal Y by adding up respective pixel signals of a total of four adjacent pixels arrayed 2×2. Further, the color solid-state image pickup device of the present embodiment creates four luminance signals Y per unit of addition.

This makes it possible to obtain, from 2×2 pixels, a luminance signal Y corresponding to one pixel. Therefore, the resolution is quadrupled (2×2=4) in comparison with the conventional adding-up method shown in FIG. 7. That is, although the resolution has conventionally been reduced to 1/16 by adding up pixels, the adding-up method of the color solid-state image pickup device of the present embodiment makes it possible to suppress a reduction in resolution by ¼. Therefore, the color solid-state image pickup device of the present embodiment makes it possible to ensure high resolution by increasing the resolution to ¼ of a full pixel.

Further, the color solid-state image pickup device of the present embodiment creates a color signal by adding up pixel signals of pixels corresponding to the same color among a total of 16 pixels in one unit of addition. For example, in (b) of FIG. 1, the color solid-state image pickup device of the present embodiment creates a color signal sC2 by adding up pixel signals corresponding to four pixels assigned color filters C2, and creates a color signal sC3 by adding up pixel signals corresponding to four pixels assigned color filters C3. That is, as indicated as “C2” and “C3” in capital and bold letters, the color solid-state image pickup device of the present embodiment creates a color signal containing color information of a color filter C2 corresponding to one pixel per unit of addition, and creates a color signal containing color information of a color filter C3 corresponding to one pixel per unit of addition.

Therefore, as for the color signals sC2 and sC3, which are lenient in resolution, the resolution is the same as the conventional resolution. However, as for the luminance signal Y, which is required to be of high resolution, the resolution is four times as high as that obtained through the conventional method. This makes it possible to obtain color signals of high resolution as total performance. Furthermore, each of the luminance signal Y and the color signals sC2 and sC3 is obtained by adding up four pixels. This makes it possible to obtain a fourfold increase in sensitivity.

Thus, the color solid-state image pickup device of the present embodiment makes it possible to achieve both high sensitivity and high resolution by inhibiting the resolution from being reduced even by adding up pixel signals.

The following describes a circuit arrangement of the color solid-state image pickup device of the present embodiment for realizing the adding up of pixel signals.

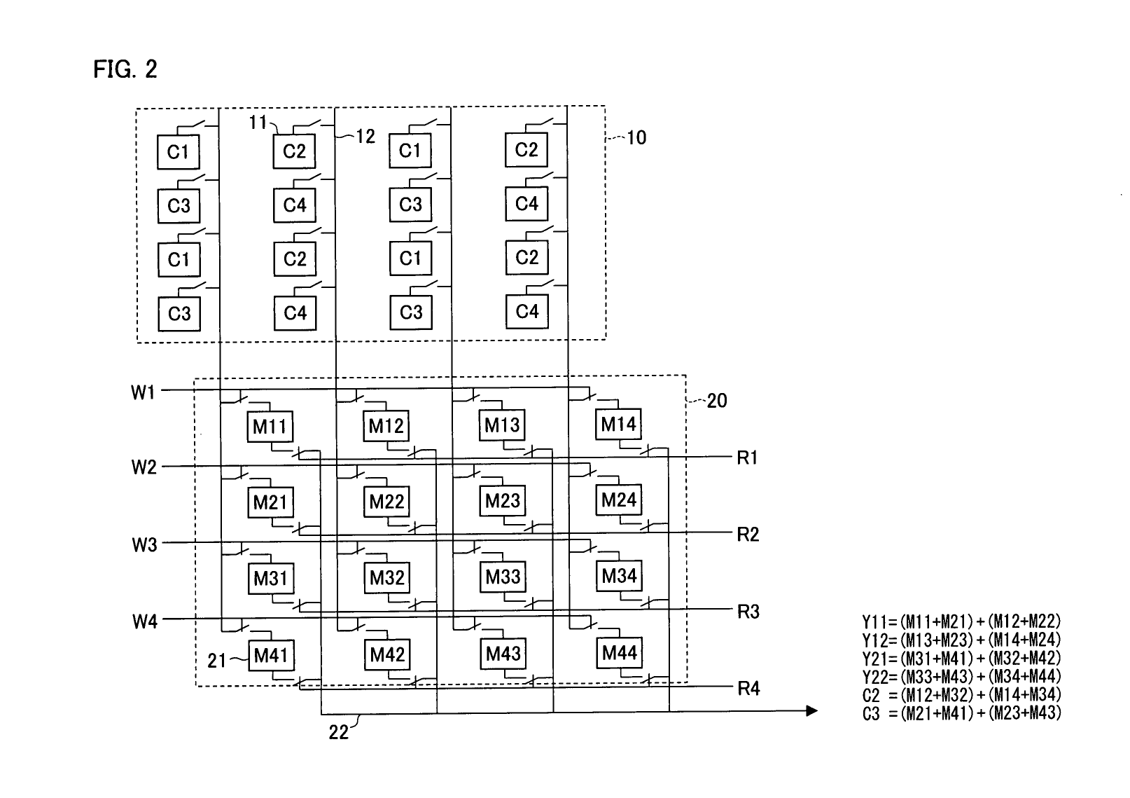

FIG. 2 is a circuit block diagram showing an example arrangement of the color solid-state image pickup device of the present embodiment. It should be noted that FIG. 2 shows an arrangement in the unit of addition shown in FIG. 1.

As shown in FIG. 2, the color solid-state image pickup device of the present embodiment includes: a pixel region 10 (pixel section) arranged so as to include pixels 11 (first to fourth pixels) and column signal lines 12; and an analog signal storage section 20 (signal storage section) arranged so as to include analog memories 21 (first to fourth storage sections), horizontal readout lines 22, write control lines W1 to W4 (control means), and readout control lines R1 to R4 (control means). The pixel region 10 is a part contained in the aforementioned pixel section. The analog signal storage section 20 is provided at a lower end of the pixel region 10 as shown in FIG. 2. However, the present invention is not limited to this. The analog signal storage section 20 may be provided at an upper or lower end of a row of pixels 11. It should be noted that a remaining part (not shown) of the color solid-state image pickup device is realized as a conventional ordinary arrangement.

The pixels 11 are disposed so as to be a total of 16 adjacent pixels 11 arrayed 4×4 in the horizontal and vertical directions. Further, the pixels 11 correspond to their respective colors because of the array of four types of color filter C1, C2, C3, and C4 shown in (a) of FIG. 1.

Each of the column signal lines 12 is a wire through which pixel signals of the pixels 11 flow. The number of column signal lines 12 provided is 4. That is, each of the column signal line 12 is formed so as to extend in the vertical direction, while making it possible to control switches so that the column signal line 12 is connected to four pixels 11 forming a column. Further, each of the column signal lines 12 is connected to analog memories 21 of the analog signal storage section 20.

Each of the analog memories 21 is a memory that stores (retains) a pixel signal, supplied from a column signal line 12, which corresponds to a pixel 11. The number of analog memories 21 provided is identical to the number of pixels 11 so that each of the analog memories 21 makes a pair with a pixel 11. That is, according to the embodiment of FIG. 2, the number of analog memories 21 provided is 16. Further, four analog memories 21 forming a column are connected while making it possible to control switches so that each of the four analog memories 21 is connected a column signal line 12.

It is assumed here that the plurality of analog memories 21 are referred to as “storage sections” for the purpose of distinguishing between the analog memories 21 as being used for pixel signals of the respective pixels 11. Then, in correspondence with one unit of addition of 4×4 pixels, four storage sections M1j, M2j, M3j, and M4j (where j indicates the number of a column) are provided for each column signal line 12 (for each column of pixels 11). For example, as for the leftmost column signal line 12 in FIG. 2, the storage sections M11, M21, M31, and M41 are provided so as to correspond to pixels 11 assigned color filters C1, C3, C1, and C3 forming a column, respectively.

Each of the horizontal readout lines 22 is a wire through which a pixel signal written to an analog memory 21 flows. The number of horizontal readout lines 22 provided 4, and the four horizontal readout lines 22 finally converge into a single horizontal readout line 22. That is, each of the four horizontal readout lines 22 yet to finally converge into the single horizontal readout line 22 is formed so as to extend in the vertical direction, while making it possible to control switches so that the horizontal readout line 22 is connected to four analog memories 21 forming a column. Moreover, the single horizontal readout line 22, into which the four horizontal readout lines 22 have finally converged, is connected to a subsequent arrangement.

Each of the write control lines W1 to W4 is a wire via which to supply a control signal for controlling the switching of a switch provided between a column signal line 12 and an analog memory 21. Each of the write control lines W1 to W4 is formed so as to extend in the horizontal direction, while being connected to switches provided between four analog memories 21 forming a row and the column signal lines 12, respectively. For example, the write control line W1 is connected to switches provided between four storage sections M11, M12, M13, and M14 forming a row and the column signal lines 12, respectively.

Each of the readout control lines R1 to R4 is a wire via which to supply a control signal for controlling the switching of a switch provided between an analog memory 21 and a horizontal readout line 22. Each of the readout control lines R1 to R4 is formed so as to extend in the horizontal direction, while being connected to switches provided between four analog memories 21 forming a row and the horizontal readout lines 22, respectively. For example, the readout control line R1 is connected to switches provided between four storage sections M11, M12, M13, and M14 forming a row and the horizontal readout lines 22, respectively.

The numbers described above with reference to the circuit arrangement of the color solid-state image pickup device of the present embodiment are merely based on the embodiment of FIG. 2 according to the number of pixels 11 obtained when a total of 16 adjacent pixels arrayed 4×4 serve as a unit of addition. The present invention is not limited to this.

The color solid-state image pickup device of the present embodiment thus arranged first controls the switches by supplying control signals via the write control lines W1 to W4, and writes pixel signals sequentially to the storage sections M11 to M44 row by row. That is, since the color solid-state image pickup device of the present embodiment has four rows of storage sections, the color solid-state image pickup device of the present embodiment writes pixel signals row by row four times, thereby writing pixel signals of one unit of addition sequentially to four storage sections. For example, the color solid-state image pickup device of the present embodiment turns on each switch by supplying a control signal to the write control line W1, so that pixel signals of pixels 11 assigned color filters C1, C2, C1, and C2 forming a row are simultaneously written to the storage sections M11, M12, M13, and M14 via the column signal lines 12, respectively.

When the color solid-state image pickup device of the present embodiment finishes writing the pixel signals corresponding to the four rows, i.e., image information, the color solid-state image pickup device of the present embodiment controls the switches by supplying control signals via the readout control lines R1 to R4, and then adds up and reads out the pixel signals written to the storage sections M11 to M44.

In so doing, as described above, the color solid-state image pickup device of the present embodiment creates a luminance signal Y by adding up respective pixel signals of a total of four adjacent pixels arrayed 2×2, creates a color signal sC2 by adding up pixel signals of pixels corresponding to the same color among a total of 16 pixels in one unit of addition, and creates a color signal sC3 by adding up pixel signals of pixels corresponding to the same color among the total of 16 pixels in one unit of addition.

That is, the color solid-state image pickup device of the present embodiment sequentially reads out four luminance signals Y11, Y12, Y21, and Y22 per unit of addition by adding up each of the following combinations:

Y11=(M11+M21)+(M12+M22);

Y12=(M13+M23)+(M14+M24);

Y21=(M31+M41)+(M32+M42); and

Y22=(M33+M43)+(M34+M44)

(where, for convenience of explanation, M11 to M44 indicate pixel signals retained in the storage sections M11 to M14, respectively).

Specifically, the color solid-state image pickup device of the present embodiment reads out luminance signals Y by adding up pixel signals written to the first row of analog memories 21 and pixel signals written to the second row of analog memories 21 (First Row+Second Row), and then reads out luminance signals Y by adding up pixel signals written to the third row of analog memories 21 and pixel signals written to the fourth row of analog memories 21 (Third Row+Fourth Row).

For example, in reading out the luminance signal Y11, the color solid-state image pickup device of the present embodiment turns on each switch by supplying control signals to the readout control lines R1 and R2, so that each of the storage sections M11, M12, M21, and M22 is connected to a horizontal readout line 22. This makes it possible to obtain the luminance signal Y11 by adding up and reading out, via the horizontal readout lines 22, pixel signals respectively stored in the storage sections M11, M12, M21, and M22.

Further, after having read out the four luminance signals Y11, Y12, Y21, and Y22, the color solid-state image pickup device of the present embodiment sequentially reads out color signals sC2 and sC3 per unit of addition by adding up each of the following combinations:

C2=(M12+M32)+(M14+M34); and

C3=(M21+M41)+(M23+M43)

(where, for convenience of explanation, C2 and C3 indicate color signals sC2 and sC3 containing color information of color filters C2 and C3, respectively; and M12, M32, M14, M34, M21, M41, M23, and M43 indicate pixel signals retained in the storage sections M12, M32, M14, M34, M21, M41, M23, and M43, respectively).

Specifically, the color solid-state image pickup device of the present embodiment reads out a color signal by adding up pixel signals of analog memories 21 to which pixel signals of the same color have been written. For example, in reading out the color signal sC2, the color solid-state image pickup device of the present embodiment turns on each switch by supplying control signals to the readout control lines R1 and R3, so that each of the storage sections M12, M14, M32, and M34 is connected to a horizontal readout line 22. This makes it possible to obtain the color signal sC2 by adding up and reading out, via the horizontal readout lines 22, pixel signals respectively stored in the storage sections M12, M14, M32, and M34.

Thus, the color solid-state image pickup device of the present embodiment reads out twice for each analog memory 21. That is, in one unit of addition, the luminance signals Y11 to Y22 can be obtained through the first adding up and readout, and the color signals sC2 and sC3 can be obtained through the second adding up and readout.

Further, since each of the luminance signals and the color signals is obtained by adding up four pixel signals, it becomes possible to obtain high sensitivity corresponding to the four pixel signals thus added up. Furthermore, at the same time, since each of the luminance signals, which determine the resolution of an image as a whole, can be obtained with high resolution in a unit of 2×2 pixels, it becomes possible to obtain color signals of high sensitivity and high resolution.

Thus, as for the luminance signals, which are required to be of high resolution, the color solid-state image pickup device of the present embodiment adds up each of the four sets of 2×2 adjacent pixels per unit of addition. As for the color signals, which are not required to be of high resolution, the color solid-state image pickup device of the present embodiment adds up pixel signals for each dispersed color (four colors each in a unit of 2×2 pixels) per unit of addition.

Moreover, in order to realize the adding up, the color solid-state image pickup device of the present embodiment includes four rows of analog memories 21 (Number of Horizontal Pixels×4 Rows) per unit of addition. The color solid-state image pickup device of the present embodiment enables adding up for luminance signals and adding up for color signals by performing timing control at the time of readout with respect to pixel data, i.e., pixel signals, written in a unit of four rows.

Performing readout according to the foregoing arrangement and technique makes it possible to obtain a signal of ever-higher resolution even by adding up pixel signals at low-light intensity. Therefore, although even an element made to high-resolution specifications, such as an 8-M element, is made equivalent to 0.5 M with the conventional method and therefore has a problem with practicality for still images, the color solid-state image pickup device of the present embodiment makes the same 8-M element equivalent to 2 M (2 million pixels), thereby making it possible to obtain an image at such a level as to have no problem with practicality. Furthermore, there occurs no color moiré phenomenon that causes a problem at the time of subsampling readout.

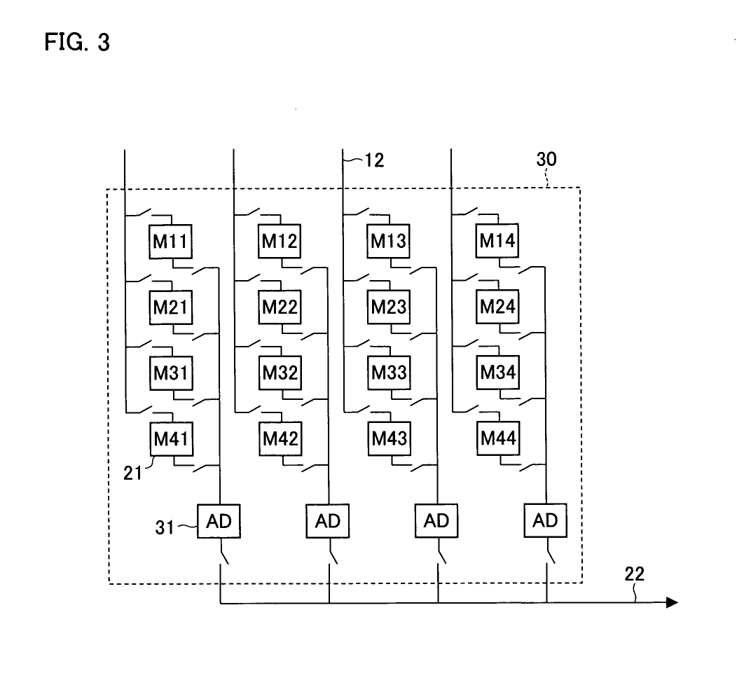

Further, the analog signal storage section 20 is not particularly limited to this arrangement. For example, the analog signal storage section 20 may be arranged as shown in FIG. 3.

FIG. 3 is a circuit block diagram showing an example arrangement of an analog signal storage section 30. It should be noted that FIG. 3 does not show a write control line and a readout control line. In addition to the arrangement of the analog signal storage section 20 of FIG. 2, the analog signal storage section 30 has AD converters 31 respectively provided for the horizontal readout lines 22 yet to converge into the single horizontal readout line 22. The AD converters 31 only need to be provided subsequent to their respective analog memories.

The analog signal storage section 30 thus arranged performs interrow adding up of pixel signals with use of analog signals obtained between the storage sections, and performs intercolumnar adding up with use of digital signals obtained from the AD converters 31 respectively provided for the columns.

The analog signal storage section 20 of FIG. 2 can perform adding up with use of analog signals without influence from quantization noise that accompanies A/D conversion, and therefore is effective in making an improvement in S/N ratio. On the other hand, the analog signal storage section 30 performs adding up ineffectively in terms of an S/N ratio, but can perform an adding-up process digitally, thereby making it possible to facilitate a process for adding up and reading out pixel signals.

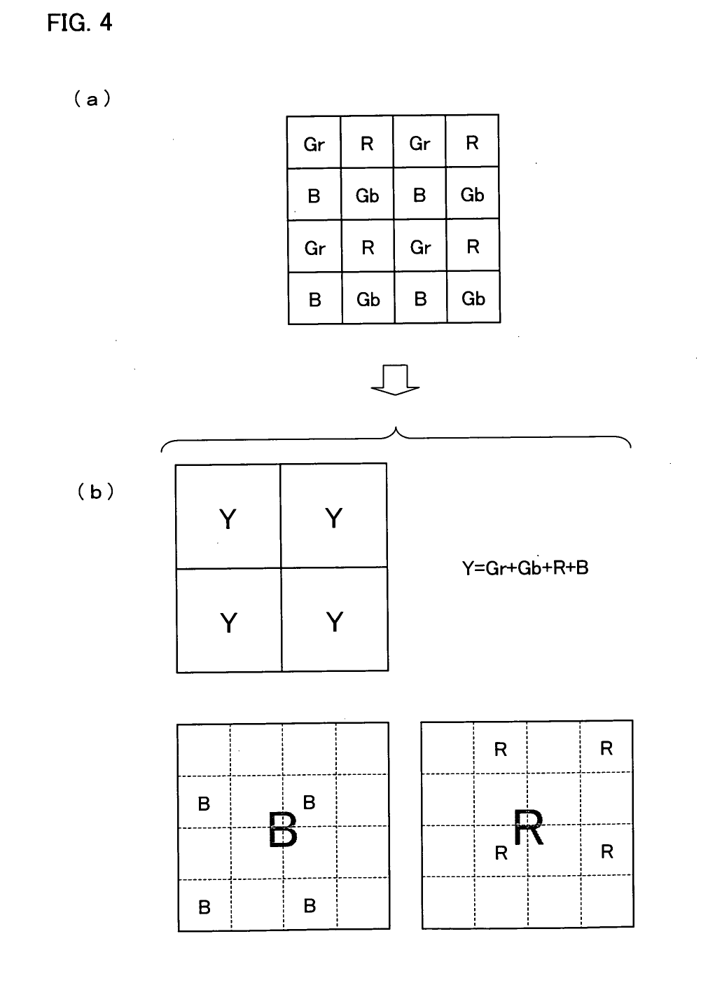

It should be noted here that the color solid-state image pickup device of the present embodiment can be applied even in the case of a Bayer array, shown in (a) of FIG. 4, in which the four types of color filter C1, C2, C3, and C4 of (a) of FIG. 1 are C1=Gr (Green 1), C2=R (Red), C3=B (Blue), and C4=Gb (Green 2), respectively.

That is, in the case of a Bayer array of color filters, as with the color filter array of (a) of FIG. 4(a), the color solid-state image pickup device of the present embodiment adds up respective pixel signals of a total of four adjacent pixels, i.e., of 2×2 adjacent pixels as shown in (b) of FIG. 4, thereby creating “Y=Gr+Gb+R+B (where, for convenience of explanation, Gr, Gb, R, and B indicate pixel signals of pixels assigned color filters Gr, Gb, R, and B, respectively)”. Moreover, the color solid-state image pickup device of the present embodiment creates a color signal sB by adding up pixel signals corresponding to four pixels assigned color filters B, and creates a color signal sR by adding up pixel signals corresponding to four pixels assigned color filters R.

This makes it possible to obtain color signals of high resolution as total performance, and to obtain a fourfold increase in sensitivity. This makes it possible to achieve both high sensitivity and high resolution even in the case of adding up pixels. This makes it possible to obtain a great effect by applying the present invention to an ordinary Bayer array.

Although the color solid-state image pickup device of the present embodiment yields a color signal by adding up respective pixel signals of four pixels corresponding to the same color among a total of 16 pixels in one unit of addition, the present invention is not limited to this. Another adding-up method may be used.

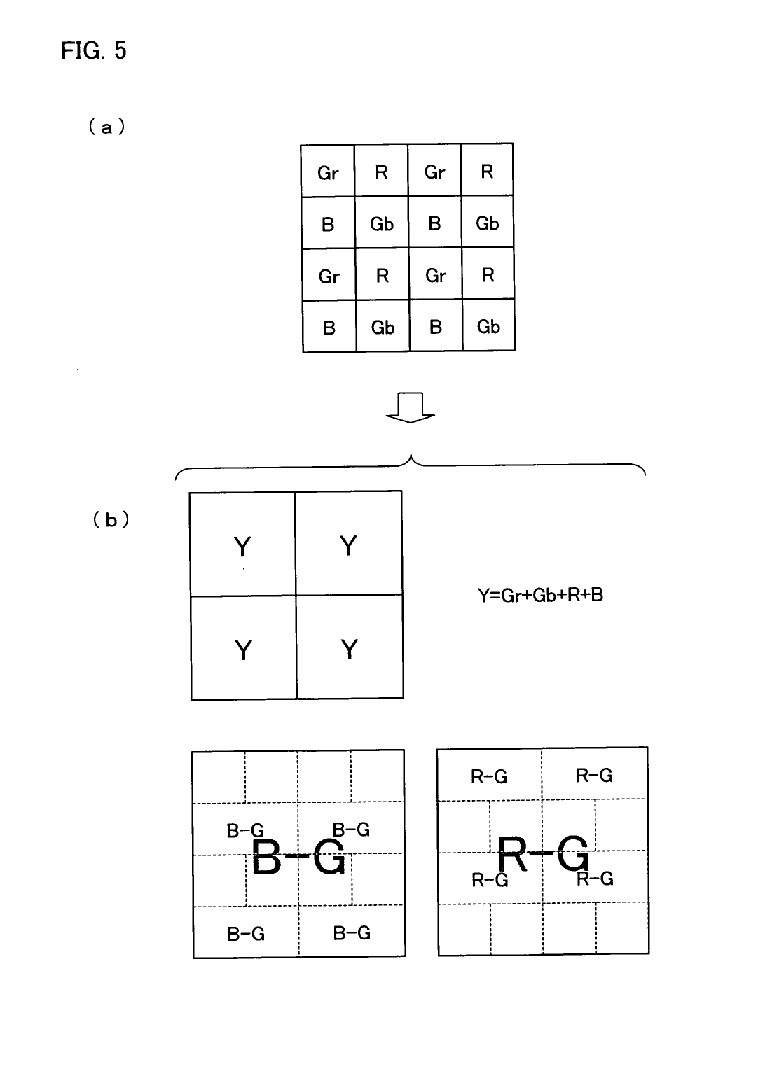

FIG. 5 explains another example method for adding up in the pixel section of the color solid-state image pickup device of the present embodiment. In FIG. 5, (a) shows a Bayer array of color filters, and (b) schematically shows a method for adding up pixel signals.

First, as shown in (b) of FIG. 4, the color solid-state image pickup device of the present embodiment creates a luminance signal Y by adding up respective pixel signals of a total of 4 adjacent pixels, i.e., of 2×2 adjacent pixels (Y=Gr+Gb+R+B).

The following explains a color signal. As shown in (b) of FIG. 5, the color solid-state image pickup device of the present embodiment creates a color difference signal s(B−Gb) by subtracting, from (i) a pixel signal of a pixel assigned a color filter B, (ii) a pixel signal of a pixel, assigned a color filter Gb, which is horizontally adjacent to the pixel assigned the color filter B. The color solid-state image pickup device of the present embodiment creates four such color difference signals s(B−Gb) per unit of addition, and creates a color signal by adding up the color difference signals s(B−Gb). Similarly, the color solid-state image pickup device of the present embodiment creates a color difference signal s(R−Gr) by subtracting, from (i) a pixel signal of a pixel assigned a color filter R, (ii) a pixel signal of a pixel, assigned a color filter Gr, which is horizontally adjacent to the pixel assigned the color filter R. The color solid-state image pickup device of the present embodiment creates four such color difference signals s(R−Gr) per unit of addition, and creates a color signal by adding up the color difference signals s(R−Gr).

That is, the color solid-state image pickup device of the present embodiment creates a color difference signal by subtracting, from (i) a pixel signal of any one of a set of pixels respectively assigned color filters Gr, Gb, R, and B, (ii) a pixel signal of a pixel horizontally adjacent to the pixel within the set, and creates a color signal by adding up and reading out four such color difference signals created from an identical combination per unit of addition.

Since even the color signal thus created is obtained by adding up pixel signals corresponding to four pixels, it becomes possible to maintain high sensitivity. Further, since the luminance signal Y maintains high resolution, it becomes possible to achieve both high sensitivity and high resolution.

Further, the color solid-state image pickup device of the present embodiment can be applied not only in the case of a Bayer array but also in the case of another array of color filters.

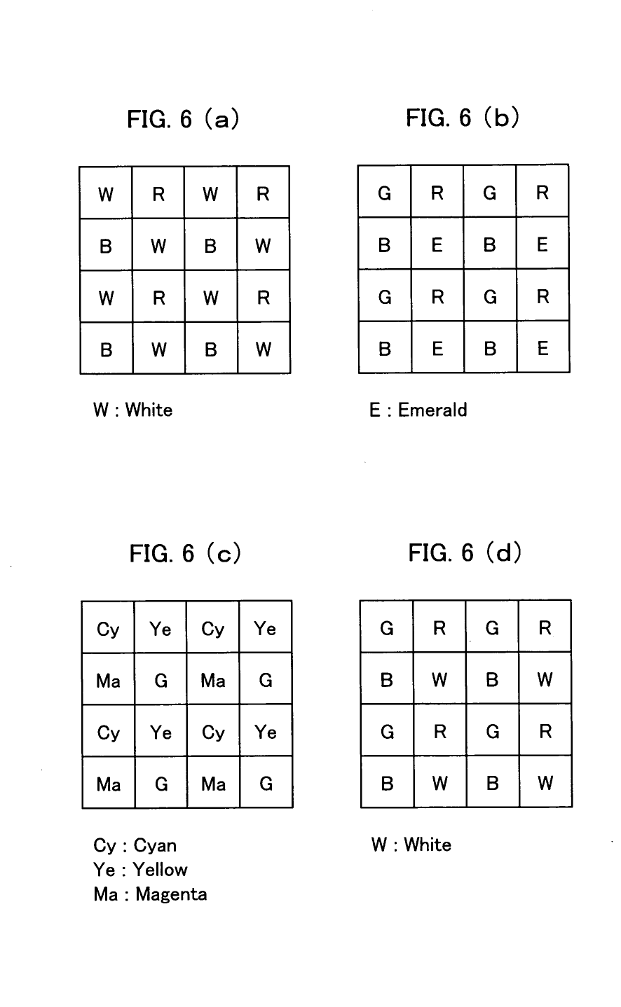

FIGS. 6(a) through 6(d) are color-filter-array diagrams according to various example arrays.

FIG. 6(a) shows an example array in which Gr (Green 1) and Gb (Green 2) of the Bayer array of (a) of FIG. 4 have been replaced by White. It should be noted that White transmits all colors. FIG. 6(b) shows an example array in which Gb (Green 2) of the Bayer array of (a) of FIG. 4 has been replaced by Emerald. FIG. 6(c) shows an example array in which the colors of the Bayer array of (a) of FIG. 4 have been replaced by complementary colors. Such an array is normally constituted by Cyan, Yellow, Magenta, and Green. FIG. 6(d) shows an example array in which Gb (Green 2) of the Bayer array of (a) of FIG. 4 has been replaced by White.

In each of the respective example arrays of FIGS. 6(a) through 6(d), a luminance signal is obtained by adding up respective signals of 2×2 adjacent pixels, and two types of color signals independent among 4×4 pixels are each obtained by adding up pixel signals corresponding to four pixels. In the case of the example array of FIG. 6(c), the adding-up method, described above with reference to FIG. 5, which reads out a color signal after having calculated color difference signals is suitable.

The present invention is not limited to the description of the embodiments above, but may be altered by a skilled person within the scope of the claims. An embodiment based on a proper combination of technical means disclosed in different embodiments is encompassed in the technical scope of the present invention.

The present invention can be applied to color solid-state image pickup devices that add up and read out pixel signals for an improvement in sensitivity of high-resolution elements. Examples of the color solid-state image pickup devices include color solid-state image pickup devices, mounted in various imaging apparatuses, such as video cameras and still cameras that take moving images and still images.

As described above, a color solid-state image pickup device of the present invention is a color solid-state image pickup device including a pixel section having sets of a total of four adjacent pixels arrayed 2×2 in horizontal and vertical directions, each of the sets consisting of an first pixel serving as an upper left pixel and having a first spectral characteristic, a second pixel serving as an upper right pixel and having a second spectral characteristic, a third pixel serving as a lower left pixel and having a third spectral characteristic, and a fourth pixel serving as a lower right pixel and having a fourth spectral characteristic, the pixel section being formed by arraying the sets in the horizontal and vertical directions so that the sets forms a matrix, the color solid-state image pickup device using, as a unit of addition, a total of 16 pixels consisting of four adjacent sets arrayed 2×2 in the horizontal and vertical directions, the color solid-state image pickup device adding up and reading out respective pixel signals of the pixels, the color solid-state image pickup device creating a luminance signal by adding up and reading out respective pixel signals of the first, second, third, and fourth pixels constituting the set.

With this, the luminance signal is created by adding up and reading out respective pixel signals of the first, second, third, and fourth pixels constituting the set. Therefore, the luminance signal, which is required to be of high resolution, is obtained in a unit of 2×2 pixels. This causes the resolution to be ½ both in the horizontal and vertical directions and ½×½ of a full pixel, so that the resolution is ¼ in total in terms of the number of pixels.

Therefore, whereas the conventional adding-up method has drastically reduced the resolution to 1/16 in total in terms of the number of pixels, the color solid-state image pickup device of the present invention can achieve a fourfold increase in resolution in comparison with the conventional adding-up method by inhibiting the resolution from being reduced by such adding up of pixel signals as performed by the conventional adding-up method. Furthermore, since the luminance signal is created by adding up pixel signals corresponding to four pixels, it becomes possible to achieve a fourfold increase in sensitivity. This brings about an effect of realizing a color solid-state image pickup device capable of achieving both high sensitivity and high resolution by inhibiting the resolution from being reduced by adding up pixel signals.

For example, a signal of ever-higher resolution can be obtain even by adding up pixel signals at low-light intensity. Therefore, although even an element made to high-resolution specifications, such as an 8-M (8 million pixels) element, is made equivalent to 0.5 M (500,000 pixels) with the conventional method and therefore has a problem with practicality for still images, the color solid-state image pickup device of the present invention makes the same 8-M element equivalent to 2 M (2 million pixels), thereby making it possible to obtain an image at such a level as to have no problem with practicality.

Further, the color solid-state image pickup device of the present invention is preferably arranged such that in the unit of addition, color signals are created by adding up and reading out pixel signals of pixels corresponding to identical colors, respectively.

According to the foregoing arrangement, the resolution of each of the color signals is 1/16 in total in terms of the number of pixels. However, the color signal is only required to be of comparatively low resolution, and the resolution of the luminance signal, which is required to be of high resolution, is four times as high as that obtained through the conventional adding-up method. This makes it possible to obtain color signals of high resolution as total performance. Furthermore, each of the color signals is obtained by adding up pixel signals corresponding to four pixels. This makes it possible to obtain a fourfold increase in sensitivity. This makes it possible to maintain high resolution, while increasing sensitivity, by inhibiting the resolution from being reduced by adding up pixel signals.

Further, the color solid-state image pickup device of the present invention is preferably arranged such that: color difference signals are each created by subtracting, from (i) a pixel signal of any one of the four pixels constituting the set, (ii) a pixel signal of a pixel horizontally adjacent to the pixel within the set; and in the unit of addition, a color signal is created by adding up and reading out four color difference signals thus created from an identical combination.

According to the foregoing arrangement, the resolution of each of the color signals is 1/16 in total in terms of the number of pixels. However, the color signal is only required to be of comparatively low resolution, and the resolution of the luminance signal, which is required to be of high resolution, is four times as high as that obtained through the conventional adding-up method. This makes it possible to obtain color signals of high resolution as total performance. Furthermore, each of the color signals is obtained by adding up pixel signals corresponding to four pixels. This makes it possible to obtain a fourfold increase in sensitivity. This makes it possible to maintain high resolution, while increasing sensitivity, by inhibiting the resolution from being reduced by adding up pixel signals. Furthermore, the creation of the color difference signals causes an increase in range of colors. This makes it possible to extend the range of reproducible colors.

Further, the color solid-state image pickup device of the present invention is preferably arranged such that: the first and fourth spectral characteristics are identical; and the color signals are a first color signal created by adding up and reading out pixel signals of four second pixels contained in the unit of addition and a second color signal created by adding up and reading out pixel signals of four third pixels contained in the unit of addition.

According to the foregoing arrangement, the unit of addition contains three types of color, thereby constituting a minimum necessary arrangement of three primary colors. Further, the foregoing arrangement makes it possible to obtain color signals simply by creating the three signals: the luminance signal, the first color signal, and the second color signal, thereby bringing about a merit of facilitating signal processing.

Further, the color solid-state image pickup device of the present invention is preferably arranged such that: the first and fourth pixels correspond to green; the second pixel corresponds to red; and the third pixel corresponds to blue.

According to the foregoing arrangement, such an array of colors is commonly known as a Bayer array. This makes it possible to obtain a great effect by applying the present invention to an ordinary Bayer array.

Further, the color solid-state image pickup device of the present invention is preferably arranged so as to further include: a signal storage section that retains pixel signals of pixel arrayed in the pixel section; and control means for controlling writing of the pixel signals to the signal storage section and readout of the pixel signals from the signal storage section, wherein: the signal storage section has, for each column of pixels, a first storage section that retains a pixel signal of a first-row pixel of the unit of addition, a second storage section that retains a pixel signal of a second-row pixel of the unit of addition, a third storage section that retains a pixel signal of a third-row pixel of the unit of addition, and a fourth storage section that retains a pixel signal of a fourth-row pixel of the unit of addition; and the control means performs control so as to add up and read out pixel signals respectively retained in the first and second storage sections in first and second columns of the unit of addition and add up and read out pixel signals respectively retained in the first and second storage sections in third and fourth columns of the unit of addition, and to add up and read out pixel signals respectively retained in the third and fourth storage sections in the first and second columns of the unit of addition and add up and read out pixel signals respectively retained in the third and fourth storage sections in the third and fourth columns of the unit of addition.

According to the foregoing arrangement, the pixel signals of the pixels arrayed in the pixel section are retained in the signal storage section having the first to fourth storage sections for each unit of addition, and the writing of the pixel signals to the signal storage section and the readout of the pixel signals from the signal storage section are controlled by the control means.

That is, the control means performs control so as to add up and read out pixel signals respectively retained in the first and second storage sections in first and second columns of the unit of addition, so that the respective pixel signals of the first, second, third, and fourth pixels are added up and read out. Further, similarly, the control means performs control so as to add up and read out pixel signals respectively retained in the first and second storage sections in third and fourth columns of the unit of addition, to add up and read out pixel signals respectively retained in the third and fourth storage sections in the first and second columns of the unit of addition, and to add up and read out pixel signals respectively retained in the third and fourth storage sections in the third and fourth columns of the unit of addition, so that the respective pixel signals of the first, second, third, and fourth pixels are added up and read out.

This results in the creation of four pixel signals thus added up and read out per unit of addition. Since the pixel signals thus added up and read out contains all color information, and therefore serve as a luminance signal. This makes it possible to easily create a luminance signal simply by including the signal storage section and the control means.

Further, the pixel section may be arranged as usual, and only needs to further include the signal storage section and the control means. This makes it possible to facilitate the application of a conventional pixel section, thereby making it possible to extend the field of application of fine pixels to a multi-pixel image pickup element.

Further, the color solid-state image pickup device of the present invention is preferably arranged such that the control means further performs control so as to add up and read out pixel signals of pixels corresponding to identical colors among a plurality of storage sections retaining pixel signals of pixels of the unit of addition, respectively.

According to the foregoing arrangement, the control means adds up and reads out pixel signals of pixels corresponding to an identical color among the plurality of storage sections. The pixel signals thus added up and read out contain a piece of color information, and therefore serve as a color signal. This makes it possible to more easily create a color signal.

Further, the color solid-state image pickup device of the present invention is preferably arranged such that the control means further performs control so as to read out pixel signals each obtained by subtracting, from (i) a pixel signal retained in any one of the four storage sections respectively retaining pixel signals of the four pixels constituting the set, (ii) a pixel signal retained in a storage section horizontally adjacent to the storage section within the set, and to add up and read out four pixel signals thus read out from an identical combination by subtraction.

According to the foregoing arrangement, after the pixel signals retained in the storage sections are read out by subtraction by the control means, the four signals thus read out from an identical combination by subtraction are added up and read out. The signals thus added up and read out contain color information, and therefore serve as a color signal. This makes it possible to more easily create a color signal. Further, after subtraction, a pixel signal, retained in a storage section, which contains a piece of color information is subtracted, so that an increase in another piece of color information causes an increase in range of colors. This makes it possible to extend the range of reproducible colors.

Further, the color solid-state image pickup device of the present invention is preferably arranged such that the pixel signals are added up in columns in the unit of addition with use of analog signals.

According to the foregoing arrangement, the analog signals can be added up without influence from quantization noise that accompanies A/D conversion. Therefore, the foregoing arrangement is effective in making an improvement in S/N ratio.

Further, the color solid-state image pickup device of the present invention is preferably arranged so as to further include AD converters respectively provided subsequent to the first, second, third, and fourth storage sections, wherein the pixel signals are added up in columns in the unit of addition with use of digital signals outputted from the AD converters.

According to the foregoing arrangement, since the AC converters are further provided, pixel signals respectively read out from the first, second, third, and fourth storage sections are processed into digital signals. Moreover, the digital signals can be added up digitally. This makes it possible to facilitate a process for adding up and reading out pixel signals.

Further, a method of the present invention for reading out pixel signals is a method for reading out pixel signals in a color solid-state image pickup device including a pixel section having sets of a total of four adjacent pixels arrayed 2×2 in horizontal and vertical directions, each of the sets consisting of an first pixel serving as an upper left pixel and having a first spectral characteristic, a second pixel serving as an upper right pixel and having a second spectral characteristic, a third pixel serving as a lower left pixel and having a third spectral characteristic, and a fourth pixel serving as a lower right pixel and having a fourth spectral characteristic, the pixel section being formed by arraying the sets in the horizontal and vertical directions so that the sets forms a matrix, the color solid-state image pickup device using, as a unit of addition, a total of 16 pixels consisting of four adjacent sets arrayed 2×2 in the horizontal and vertical directions, the color solid-state image pickup device adding up and reading out respective pixel signals of the pixels, the method including: a first step of creating a luminance signal by adding up and reading out respective pixel signals of the first, second, third, and fourth pixels constituting the set; and a second step of, in the unit of addition, creating color signals by adding up and reading out pixel signals of pixels in accordance with colors corresponding to the pixels, respectively.

With this, the luminance signal is created by adding up and reading out respective pixel signals of the first, second, third, and fourth pixels constituting the set. Further, the color signals are created after the luminance signal. This makes it possible to easily obtain color signals.

Further, the luminance signal, which is required to be of high resolution, is obtained in a unit of 2×2 pixels. This causes the resolution to be ½ both in the horizontal and vertical directions and ½×½ of a full pixel, so that the resolution is ¼ in total in terms of the number of pixels.

Therefore, whereas the conventional adding-up method has drastically reduced the resolution to 1/16 in total in terms of the number of pixels, the color solid-state image pickup device of the present invention can achieve a fourfold increase in resolution in comparison with the conventional adding-up method. Furthermore, since the luminance signal is created by adding up pixel signals corresponding to four pixels, it becomes possible to achieve a fourfold increase in sensitivity. This brings about an effect of providing a method for reading out pixel signals, which can achieve both high sensitivity and high resolution by inhibiting the resolution from being reduced by adding up pixel signals.

Further, the method of the present invention for reading out pixel signals is preferably arranged such that the second step includes, in the unit of addition, creating the color signals by adding up and reading out pixel signals of pixels corresponding to identical colors, respectively.

According to the foregoing arrangement, the resolution of each of the color signals is 1/16 in total in terms of the number of pixels. However, the color signal is only required to be of comparatively low resolution, and the resolution of the luminance signal, which is required to be of high resolution, is four times as high as that obtained through the conventional adding-up method. This makes it possible to obtain color signals of high resolution as total performance. Furthermore, each of the color signals is obtained by adding up pixel signals corresponding to four pixels. This makes it possible to obtain a fourfold increase in sensitivity. This makes it possible to maintain high resolution, while increasing sensitivity, by inhibiting the resolution from being reduced by adding up pixel signals.

Further, the method of the present invention for reading out pixel signals is preferably arranged such that the second step includes the steps of: creating color difference signals each by subtracting, from (i) a pixel signal of any one of the four pixels constituting the set, (ii) a pixel signal of a pixel horizontally adjacent to the pixel within the set; and in the unit of addition, creating a color signal by adding up and reading out four color difference signals thus created from an identical combination.

According to the foregoing arrangement, the resolution of each of the color signals is 1/16 in total in terms of the number of pixels. However, the color signal is only required to be of comparatively low resolution, and the resolution of the luminance signal, which is required to be of high resolution, is four times as high as that obtained through the conventional adding-up method. This makes it possible to obtain color signals of high resolution as total performance. Furthermore, each of the color signals is obtained by adding up pixel signals corresponding to four pixels. This makes it possible to obtain a fourfold increase in sensitivity. This makes it possible to maintain high resolution, while increasing sensitivity, by inhibiting the resolution from being reduced by adding up pixel signals. Furthermore, the creation of the color difference signals causes an increase in range of colors. This makes it possible to extend the range of reproducible colors.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A color solid-state image pickup device comprising a pixel section having sets of a total of four adjacent pixels arrayed 2×2 in horizontal and vertical directions, each of the sets consisting of an first pixel serving as an upper left pixel and having a first spectral characteristic, a second pixel serving as an upper right pixel and having a second spectral characteristic, a third pixel serving as a lower left pixel and having a third spectral characteristic, and a fourth pixel serving as a lower right pixel and having a fourth spectral characteristic, the pixel section being formed by arraying the sets in the horizontal and vertical directions so that the sets forms a matrix, the color solid-state image pickup device using, as a unit of addition, a total of 16 pixels consisting of four adjacent sets arrayed 2×2 in the horizontal and vertical directions, the color solid-state image pickup device adding up and reading out respective pixel signals of the pixels,
the color solid-state image pickup device creating a luminance signal by adding up and reading out respective pixel signals of the first, second, third, and fourth pixels constituting the set.

2. The color solid-state image pickup device as set forth in claim 1, wherein in the unit of addition, color signals are created by adding up and reading out pixel signals of pixels corresponding to identical colors, respectively.

3. The color solid-state image pickup device as set forth in claim 2, wherein:
the first and fourth spectral characteristics are identical; and
the color signals are a first color signal created by adding up and reading out pixel signals of four second pixels contained in the unit of addition and a second color signal created by adding up and reading out pixel signals of four third pixels contained in the unit of addition.

4. The color solid-state image pickup device as set forth in claim 1, wherein:
color difference signals are each created by subtracting, from (i) a pixel signal of any one of the four pixels constituting the set, (ii) a pixel signal of a pixel horizontally adjacent to the pixel within the set; and
in the unit of addition, a color signal is created by adding up and reading out four color difference signals thus created from an identical combination.

5. The color solid-state image pickup device as set forth in claim 1, wherein:
the first and fourth pixels correspond to green;
the second pixel corresponds to red; and
the third pixel corresponds to blue.

6. The color solid-state image pickup device as set forth in claim 1, further comprising:
a signal storage section that retains pixel signals of pixel arrayed in the pixel section; and
control means for controlling writing of the pixel signals to the signal storage section and readout of the pixel signals from the signal storage section, wherein:
the signal storage section has, for each column of pixels, a first storage section that retains a pixel signal of a first-row pixel of the unit of addition, a second storage section that retains a pixel signal of a second-row pixel of the unit of addition, a third storage section that retains a pixel signal of a third-row pixel of the unit of addition, and a fourth storage section that retains a pixel signal of a fourth-row pixel of the unit of addition; and
the control means performs control so as to add up and read out pixel signals respectively retained in the first and second storage sections in first and second columns of the unit of addition and add up and read out pixel signals respectively retained in the first and second storage sections in third and fourth columns of the unit of addition, and to add up and read out pixel signals respectively retained in the third and fourth storage sections in the first and second columns of the unit of addition and add up and read out pixel signals respectively retained in the third and fourth storage sections in the third and fourth columns of the unit of addition.

7. The color solid-state image pickup device as set forth in claim 6, wherein the control means further performs control so as to add up and read out pixel signals of pixels corresponding to identical colors among a plurality of storage sections retaining pixel signals of pixels of the unit of addition, respectively.

8. The color solid-state image pickup device as set forth in claim 6, wherein the control means further performs control so as to read out pixel signals each obtained by subtracting, from (i) a pixel signal retained in any one of the four storage sections respectively retaining pixel signals of the four pixels constituting the set, (ii) a pixel signal retained in a storage section horizontally adjacent to the storage section within the set, and to add up and read out four pixel signals thus read out from an identical combination by subtraction.

9. The color solid-state image pickup device as set forth in claim 6, wherein the pixel signals are added up in columns in the unit of addition with use of analog signals.

10. The color solid-state image pickup device as set forth in claim 6, further comprising AD converters respectively provided subsequent to the first, second, third, and fourth storage sections, wherein
the pixel signals are added up in columns in the unit of addition with use of digital signals outputted from the AD converters.

11. A method for reading out pixel signals in a color solid-state image pickup device including a pixel section having sets of a total of four adjacent pixels arrayed 2×2 in horizontal and vertical directions, each of the sets consisting of an first pixel serving as an upper left pixel and having a first spectral characteristic, a second pixel serving as an upper right pixel and having a second spectral characteristic, a third pixel serving as a lower left pixel and having a third spectral characteristic, and a fourth pixel serving as a lower right pixel and having a fourth spectral characteristic, the pixel section being formed by arraying the sets in the horizontal and vertical directions so that the sets forms a matrix, the color solid-state image pickup device using, as a unit of addition, a total of 16 pixels consisting of four adjacent sets arrayed 2×2 in the horizontal and vertical directions, the color solid-state image pickup device adding up and reading out respective pixel signals of the pixels,
the method comprising:
a first step of creating a luminance signal by adding up and reading out respective pixel signals of the first, second, third, and fourth pixels constituting the set; and
a second step of, in the unit of addition, creating color signals by adding up and reading out pixel signals of pixels in accordance with colors corresponding to the pixels, respectively.

12. The method as set forth in claims 11, wherein the second step includes, in the unit of addition, creating the color signals by adding up and reading out pixel signals of pixels corresponding to identical colors, respectively.

13. The method as set forth in claims 11, wherein the second step includes the steps of:
creating color difference signals each by subtracting, from (i) a pixel signal of any one of the four pixels constituting the set, (ii) a pixel signal of a pixel horizontally adjacent to the pixel within the set; and
in the unit of addition, creating a color signal by adding up and reading out four color difference signals thus created from an identical combination.
